(19) United States
(12) Patent Application Publication
(10) Pub. No.: US 2007/0036576 A1
(43) Pub. Date: Feb. 15, 2007

(54) High voltage power supply with digital control and method of generating high voltage

(76) Inventors: Jong-hwa Cho, Suwon-si (KR); Chul-woo Oh, Suwon-si (KR)

Correspondence Address: STANZIONE & KIM, LLP, 919 18TH STREET, N.W., SUITE 440, WASHINGTON, DC, 20006, US

(21) Appl. No.: 11/371,099

(22) Filed: Mar. 9, 2006

(30) Foreign Application Priority Data
Aug. 11, 2005 (KR) 2005-73802

(51) Int. Cl. G03G 15/00

(52) U.S. Cl. 399/88

(57) ABSTRACT

A high voltage power supply (HVPS) with digital control and a method of generating high voltage. The HVPS may include switching units to intermit a current flowing in a primary side coil of a transformer and to control a voltage induced into a secondary side coil of the transformer, digital control units to control the intermission of the switching units in response to an input control data, and a digital interface unit to provide the digital control units with the control data extracted from a control code that is transferred according to a predetermined communication protocol. Because the number of parts used for the HVPS is reduced, a printed circuit board space is used more efficiently and an overall process yield is increased.

### CROSS-REFERENCE TO RELATED APPLICATIONS

This application claims priority under 35 U.S.C. § 119(a) of Korean Patent Application No. 2005-73802, filed Aug. 11, 2005 in the Korean Intellectual Property Office, the entire contents of which are incorporated herein by reference.

### BACKGROUND OF THE INVENTION

1. Field of the Invention

The present general inventive concept relates in general to a high voltage power supply (HVPS) and a method thereof, and more specifically, to a HVPS with digital control and a method of generating high voltage.

2. Description of the Related Art

An image forming apparatus, such as a printer, a copy machine, or a fax machine, is an apparatus for printing an image corresponding to an original image data onto a recording medium, such as a printing paper. Electrophotographic technology used in the image forming apparatus is also adopted by other image forming apparatuses, e.g., laser beam printers, LPH (LED Print Head) printers, fax machines, etc. An electrophotographic image forming apparatus performs a printing operation through a series of steps comprising charging, exposure, developing, transfer, and fixing processes.

FIG. 1 is a schematic cross-sectional view illustrating a conventional electrophotographic image forming apparatus. Referring to FIG. 1, the electrophotographic image forming apparatus includes a photosensitive drum 1, a charging roller 2, a laser scanning unit (LSU) 3, a developing roller 4, a transfer roller 5, a control unit 6, and a high voltage power supply (HVPS) 70.

To perform the printing operation of the electrophotographic image forming apparatus with the above-described configuration, the HVPS 70 impresses a predetermined voltage to the charging roller 2, the developing roller 4 and the transfer roller 5, under control of the control unit 6. The charging roller 2 evenly charges the surface of the photosensitive drum 1 with a charging voltage impressed from the HVPS 70. The LSU 3 scans the photosensitive drum 1 with light in response to an input image data from the control unit 6. As a result, an electrostatic latent image is formed on the surface of the photosensitive drum 1.

Later, a toner image is formed on the electrostatic latent image with a toner supplied by the developing roller 4. The transfer roller 5, which is driven by a transfer voltage impressed from the HVPS 70, transfers the toner image formed on the photosensitive drum 1 onto a sheet of printing paper. Then, the toner image transferred onto the printing paper is fixed by high heat and high pressure from a fixer (not illustrated), and the paper bearing the fixed image is discharged to outside of the apparatus along the discharge direction (not illustrated), thereby completing the printing operation.

The HVPS 70 is a key component of a copy machine, a laser beam printer, a fax machine, etc. It is a device that converts low voltage (12-24V) to high voltage (several hundreds to several thousands of volts), and forms a high voltage discharge over a printer drum or a copy machine drum, thereby enabling document printing operations. Depending on a purpose of its application, the HVPS may be used as a constant voltage regulator or a constant current generator by sending a voltage or current.

FIG. 2 is a circuit diagram illustrating the conventional HVPS in FIG. 1. Referring to FIG. 2, the conventional HVPS includes a low pass filter 10 having resistors R₁, R₂, and R₁₅ and capacitors C₁ and C₁₀, a voltage control unit 20 having resistors R₃ and R₄, comparator IC₁, and capacitor C₂, an oscillator and transformer 30 having transistor Q, power course V_{cc}, resistor R₅, capacitor C₃, and transformers V_{T2} and V_{T1} having coils N₁, N₂, and N₃, a voltage multiplier 40 having rectifying diodes D₁ and D₂, voltage multiplying and smoothing capacitors C₄ and C₅, resistor R₆, and load R_{LOAD}, a voltage sensing unit 50 having resistors R₇, R₈, R₁₀, R₁₁, R₁₂, and R₁₆, capacitors C₇ and C₈, comparator IC₂, and a protection unit 60 having resistors R₁₃ and R₁₅, amplifier IC₃, and diode D₃, D₄.

When a PWM (Pulse Width Modulation) signal D(t), whose output voltage level is determined by a duty ratio, is input (for example from an engine controller) the low pass filter 10 changes the input signal to a DC signal through a second-order RC filter having the resistor R₂ and the capacitor C₁₀and outputs the low-pass filtered DC signal. This DC signal is used as a reference signal for the output voltage control.

The voltage control unit 20 operates as a difference circuit and controller, amplifying an error signal. Specifically, the voltage control unit 20 compares the DC signal having passed through the low pass filter 10 to a feedback signal obtained from an actual output voltage, and generates a driving signal of the transistor Q of the oscillator and transformer 30.

The oscillator and transformer 30 controls the amount of base current of the transistor Q based on the output signal from the voltage control unit 20. As the voltage between an emitter and a collector of the transistor Q changes, the voltage of a primary side coil of the transformer 30 gets changed and an AC voltage is induced into a secondary side coil of the transformer 30 with a high ratio of turns.

The voltage multiplier 40 generates a final high DC voltage from the AC voltage induced into the secondary side coil of the voltage transformer 30, using the rectifying diodes D₁ and D₂ and the voltage multiplying and smoothing capacitors C₄ and C₅. The voltage sensing unit 50 and the protection unit 60 sense an actual output voltage and generate the feedback signal for the voltage control unit 20, thereby preventing application of an abnormal voltage.

The conventional HVPS illustrated in FIG. 2 is a circuit for generating high voltage to a developing unit of a particular channel. Thus, to impress a predetermined high voltage to the charging roller 2, the developing roller 4 and the transfer roller 5, for example, a separate channel for each is required.

For precise output control of an individual channel, however, the conventional HVPS typically adopts an analog control system. Therefore, it is necessary to correct an error caused by a deviation in characteristics of apparatus components, such as the RC filter and the voltage control unit 20.

Since a number of parts are used, cost reduction is not easy. Moreover, the entire HVPS may malfunction due to one or more defects in a unit component caused by external factors. Moreover, because the transistor Q functioning as a switching element in the oscillator and transformer 30 always operates in a linear area, it always generates heat.

Besides, as illustrated in FIG. 2, the conventional HVPS uses a lot of components, which requires a substantial amount of work and time in the apparatus' assembly process. Furthermore, the conventional HVPS has more space needs for the PCB (Printed Circuit Board). where many components are arranged. In addition, fixedly connected components of the conventional HVPS make it more difficult to control the output voltage.

Especially when the conventional HVPS technology is adopted for a color image forming apparatus where 4 channels in an isochronous transfer mode must be individually ensured, four conventional HVPS i.e., four of the HVPS illustrated in FIG. 2, are required. In this case, however, (i.e., in the case of multiple conventional HVPSs) the above-described problems get worse.

### SUMMARY OF THE INVENTION

The present general inventive concept provides a high voltage power supply (HVPS) with digital control and a method of generating high voltage.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a high voltage power supply, including switching units to intermit a current flowing in a primary side coil of a switch-connected transformer to control a voltage induced into a secondary side coil of the transformer, digital control units to control the intermission of the switching units in response to input control data, and a digital interface unit to provide the digital control units with the control data.

The control data may determine at least one of a waveform of an output voltage, a magnitude of the output voltage, and whether to output the output voltage.

The switching units, the digital interface unit, and the digital control units may be provided on a single chip.

The digital control unit may receive a signal corresponding to an output voltage of the secondary side of the transformer as a feedback signal, and controls a cycle of the intermission of the switching unit based on a result of a comparison between the feedback signal and the control data.

The switching units may use a MOSFET as a switching element for the intermission.

The control data may be extracted from a control code that is transferred according to a predetermined communication protocol

The foregoing and/or other aspects and utilities of the present general inventive concept may also be achieved by providing an image forming apparatus including a high voltage power supply to generate a voltage, the high voltage power supply including switching units to intermit a current flowing in a primary side coil of a switch-connected transformer to control a voltage induced into a secondary side coil of the transformer, digital control units to control the intermission of the switching units in response to input control data, and a digital interface unit to provide the digital control units with the control data.

The foregoing and/or other aspects and utilities of the present general inventive concept may also be achieved by providing a method of generating a high voltage, the method including extracting control data from a control code transferred according to a predetermined communication protocol, controlling a switching operation of a switching element in response to the control data, and intermitting a current flowing in a primary side coil of a switch-connected transformer to control a voltage induced into a secondary side coil of the transformer, according to the switching operation.

The method may further include receiving an output voltage of the secondary side of the transformer as a feedback signal, and controlling a cycle of the switching operation based on a result of a comparison between the feedback signal and the control data.

The extracting, the controlling, the intermitting, and the receiving operations may be executed in a single chip.

The switching element may be a MOSFET.

The foregoing and/or other aspects and utilities of the present general inventive concept may also be achieved by providing an application-specific integrated circuit chip embodied in a semiconductor substrate, including switching units to intermit a current flowing in a primary side coil of a switch-connected transformer to control a voltage induced into a secondary side coil of the transformer, digital control units to control the intermission of the switching units in response to an input control data, and a digital interface unit to provide the digital control units with the control data.

The application-specific integrated circuit chip may further include a feedback circuit unit to receive an output voltage of the secondary side of the transformer as a feedback signal, and to control a cycle of the intermission of the switching units based on a result of a comparison between the feedback signal and the control data.

A switching element of the switching units may be a MOSFET.

The control data is extracted from a control code which is transferred according to a predetermined communication protocol.

The foregoing and/or other aspects and utilities of the present general inventive concept may also be achieved by providing an application-specific integrated circuit chip, including a digital interface unit to receive control data and to convert the control data into a predetermined format, a plurality of digital control units to compare the converted control data to a signal reference value and to output driving signals according to the comparison, a plurality of switching units corresponding to the plurality of digital control units to receive the driving signals and to control a final voltage output, and a plurality of output units connected to respective ones of the plurality of switching units to output the final voltage.

The foregoing and/or other aspects and utilities of the present general inventive concept may also be achieved by providing a high voltage power supply comprising a single application-specific integrated circuit chip, the chip including a digital interface unit to receive control data and to convert the control data into a predetermined format, a plurality of digital control units to compare the converted control data to a signal reference value and to output driving signals according to the comparison, a plurality of switching units corresponding to the plurality of digital control units to receive the driving signals and to control a final voltage output, and a plurality of output units connected to respective ones of the plurality of switching units to output the final voltage. Each of the plurality of output units may include a transformer, a voltage multiplying circuit, and a rectifier. The plurality of switching units may be serially-connected to the transformers of respective ones of the plurality of output units to generate alternate currents of high potential to a secondary side of the transformers. Each of the plurality of switching units may include a MOSFET, and the high voltage power supply may not include an insulating plate. The chip may further include an oscillator to generate clocks, and a power-on reset unit to supply a reset signal to the digital interface unit.

The foregoing and/or other aspects and utilities of the present general inventive concept may also be achieved by providing an electrophotographic image forming apparatus, including a photoconducting unit, a charging unit, a scanning unit, a developing unit, a control unit, a high voltage power supply including a single application-specific integrated circuit chip to receive control data and to output driving signals according to the control data, and an output unit having a transformer to generate one or more high voltages according to the drive signals, in which one or more of the photoconductive unit, the charging unit, the scanning unit, and the developing unit operate according to corresponding ones of the high voltages. The single application-specific integrated circuit chip may include a digital interface unit to receive control data from the control unit and to convert the control data into a predetermined format, a plurality of digital control units to compare the converted control data to a signal reference value and to output driving signals according to the comparison, a plurality of switching units corresponding to the plurality of digital control units to receive the driving signals and to control a final voltage output, and a plurality of output units connected to respective ones of the plurality of switching units to output the final voltage. The apparatus may be a multi-color laser beam printer.

The foregoing and/or other aspects and utilities of the present general inventive concept may also be achieved by providing a method of generating a high voltage, including converting control data into a predetermined format in a digital interface unit, comparing the converted control data to a signal reference value in a plurality of digital control units, outputting driving signals according to the comparison from the plurality of digital control units, receiving the driving signals in a plurality of switching units corresponding to the plurality of digital control units, controlling a final voltage output, and outputting the final voltage using a plurality of output units connected to respective ones of the plurality of switching units. The digital interface unit, the plurality of digital control units, the plurality of switching units, and the plurality of output units may be located on a single application-specific integrated circuit chip.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-sectional view illustrating a conventional image forming apparatus;

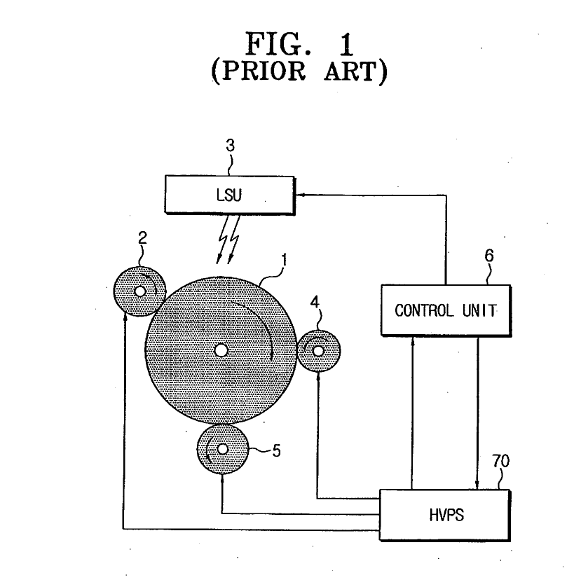

FIG. 2 illustrates a circuit configuration used in the conventional high voltage power supply of FIG. 1;

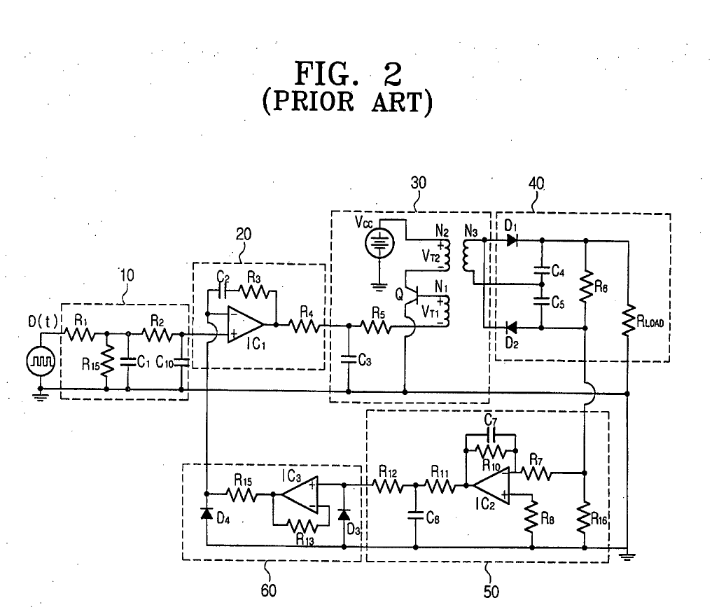

FIG. 3 is a block diagram illustrating an HVPS according to an embodiment of the present general inventive concept;

FIG. 4A illustrates a conventional application of an application-specific integrated circuit chip to a multi-color laser beam printer; and

FIG. 4B illustrates an application-specific integrated circuit chip applied to a Tandem type multi-color laser beam printer according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A high voltage power supply (HVPS) according to an embodiment of the present general inventive concept may include a digital control chip or an ASIC (application-specific integrated circuit) chip having a combination of diverse analog elements.

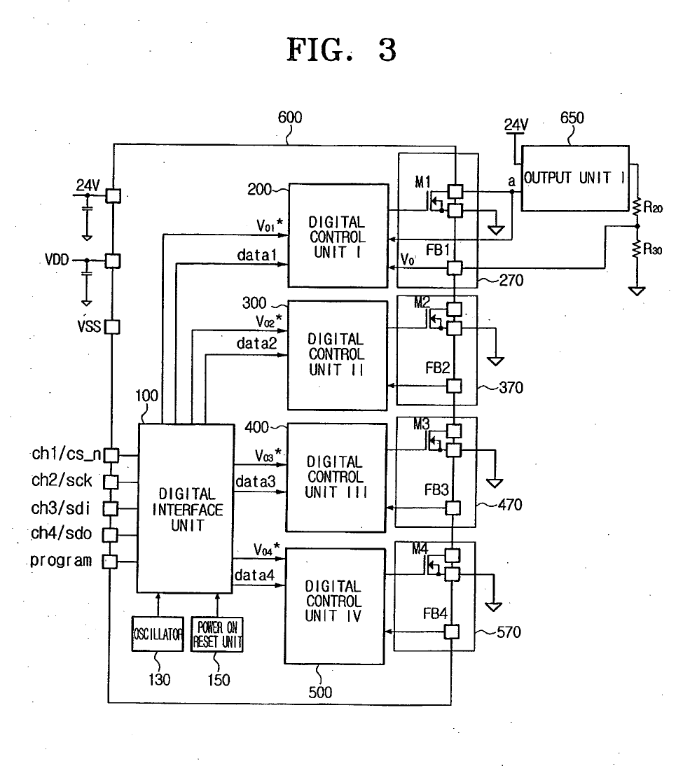

FIG. 3 is a block diagram illustrating an HVPS 600 according to an embodiment of the present general inventive concept. Referring to FIG. 3, the HVPS includes a digital interface unit 100, an oscillator 130, a power-on reset unit 150, first to fourth digital control units 200, 300, 400, and 500, and first to fourth switching units 270, 370, 470 and 570, which are provided on a single-chip ASIC.

In addition, output units that each include a transformer and a voltage multiplying circuit are connected to respective ones of the first to fourth switching units 270, 370, 470 and 570. For convenience, FIG. 3 illustrates only a first output unit 650 connected to the first switching unit 270. However, each of the first to fourth switching units 270, 370, 470 and 570 may be connected to respective output units. As illustrated in FIG. 3, the first switching unit 270 is serially connected to a transformer of the first output unit 650 to generate an alternate current of high potential to a secondary side of the transformer of the first output unit 650 according to a switching method. Alternatively, the first switching unit 270 may be operated by an oscillator method.

The digital interface unit 100 receives control data ch1/cs_n, ch2/sck, ch3/sdi, ch4/sdo, and program for determining a waveform and/or a magnitude of an output voltage input from, for example, an engine control unit. A format of the control data may be appropriate for a PWM (Pulse Width Modulation) system whose output voltage level is determined according to a duty ratio. Alternatively, the format of the control data may be appropriate for serial communication interfaces, including a UART (Universal Asynchronous Receiver/Transmitter), an SPI (Serial Peripheral Interface) bus exchanging data between two devices through serial communication, an I2C (which is a two wire bi-directional bus), and the like.

The digital interface unit 100 converts the control data input from, for example, the engine control unit, into a predetermined format, and transfers the formatted control data to the first to fourth digital control units 200, 300, 400, and 500, respectively, where the formatted control data are used as time constants data1, data2, data3, and data4 to determine the waveform of the output voltage, and control reference values V₀₁*, Vₒ₂*, V₀₃*, and V₀₄* to determine the magnitude of the output voltage.

The first to fourth digital control units 200, 300, 400, and 500 are identical in their configuration and function. In detail, each of the first to fourth digital control units 200, 300, 400, and 500 compares the control reference values Vₒ₁*, Vₒ₂*, Vₒ₃*, and Vₒ₄* (provided from the digital interface unit 100) with a signal reference value Vo (which is obtained from a junction between resistors R₂₀ and R₃₀ by sensing and feedbacking the actual output voltage of each channel), and outputs a driving signal for a corresponding switching element among the first to fourth switching units 270, 370, 470, and 570 according to the comparison result. The first digital control unit 200 may generate the driving signal according to the control reference value V₀₁, the signal reference value Vₒ, and a feedback signal FB1 obtained from a junction “a.”

The first to fourth switching units 270, 370, 470, and 570 are built in the single-chip ASIC chip. MOSFET (metal oxide semiconductor field-effect transistor) M1, M2, M3, and M4 may be used as the switching units. The first to fourth switching units 270, 370, 470, and 570 are designed to be turned on/off by application of driving signals output from each of the first to fourth digital control units 200, 300, 400, and 500 to corresponding MOSFET gates, thereby controlling voltage across a primary side coil of the transformer that is serially connected to a drain. Unlike a conventional HVPS, embodiments of the present general inventive concept use the MOSFET as the switching element, thereby eliminating a need for an insulating plate, which is necessary in a conventional HVPS to prevent heat generation by a transistor in the conventional HVPS.

The first output unit 650 includes a transformer, a voltage multiplier, and a rectifier. The transformer is serially connected to the first switching element 270, and is built to generate an AC signal while being resonated serially according to an on/off operation of the first switching element 270. Therefore, an AC voltage with a high potential is induced into a secondary side coil of the transformer. Depending on a range of output voltage of the secondary side coil of the transformer, the AC voltage generated by the transformer is either rectified by the rectifier or boosted through a multiplying circuit of the voltage multiplier and used as a final output voltage.

That is, according to the range of the output voltage, the rectifier rectifies the induced AC voltage into the secondary coil of the transformer, or the voltage multiplier boosts the induced AC voltage through the multiplying circuit to output the voltage as a final output voltage. Furthermore, the HVPS 600 includes the oscillator 130 to serve as a clock generator, and the power on reset unit 150 to supply a reset signal when power is on. In embodiments, a 24V (a high voltage supply source) and a VDD (integrated circuit driving power supply source), and a VSS power supply may also be included in the HVPS 600, as illustrated in FIG. 3.

With this configuration, the HVPS controls the output unit of each channel (e.g., the first output unit 650 for a first channel through the first digital control unit 200) according to control data (provided from, for example, the engine control unit) and generates high voltage. Moreover, when a high voltage component is desired in addition to a DC constant voltage component, a separated circuit may be configured to output a required high voltage through a PCB assembly. Each channel corresponds to a path through which a voltage is supplied to one of a photosensitive drum, a charging roller, a laser scanning unit, a developing roller, a transfer roller and so on.

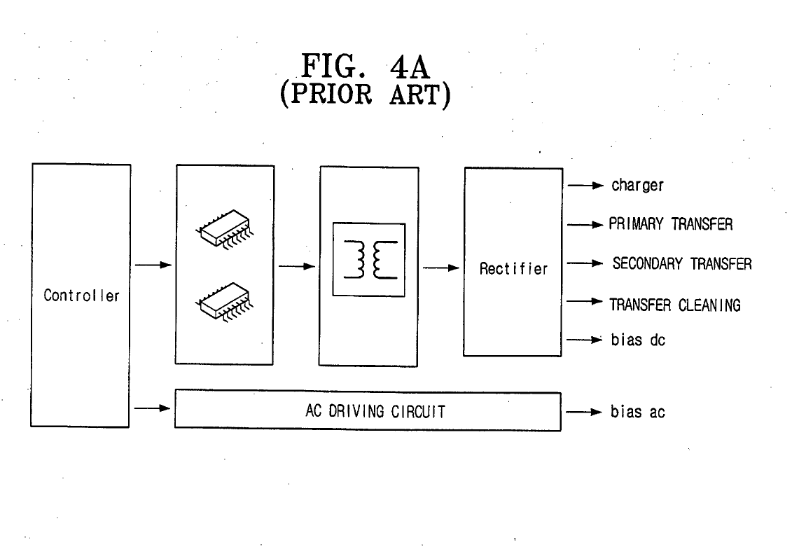

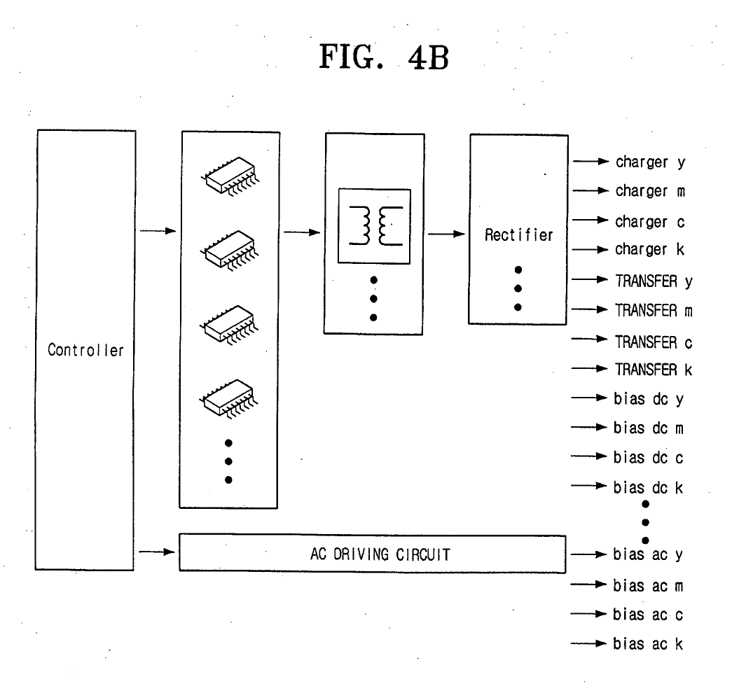

FIG. 4A illustrates a conventional application of an ASIC chip to an image forming apparatus, such as a multi-color laser beam printer (C-LBP), and FIG. 4B illustrates an ASIC chip applied to a Tandem type C-LBP according to an embodiment of the present general inventive concept.

Referring to FIG. 4A, when the ASIC chip is conventionally-applied to the C-LBP that uses a plurality of channels, paper feeding and transfer processes take place a number of times, and therefore, output speed is delayed. In contrast, referring to FIG. 4B, when the ASIC chip applied to the Tandem-type C-LBP according to an embodiment of the present general inventive concept, the ASIC chip driving a plurality of channels ensures an isochronous transfer mode at individual channels. Consequently, color image output speed is maintained or increased.

According to the present general inventive concept, since a number of parts used for an HVPS is reduced, PCB space is used more efficiently and an overall process yield is increased. Furthermore, a digital controller in an ASIC chip makes it possible to more actively cope with load variations connected to an output side, and/or to cope with unpredictable developing process fluctuations. Also, by incorporating a transistor of an analog system into the ASIC chip, small-sized ASIC chips featuring minimum heat generation can be manufactured.

These merits become more apparent when an ASIC chip is applied to an HVPS in a Tandem-type C-LBP according to an embodiment of the present general inventive concept. The reduced number of parts and the increased amount of space open the possibility of a more efficient design process for the PCB. In addition, expandability of PCB space has been improved in that a separate circuit for outputting a high voltage component in addition to a DC constant voltage output can be easily added to the PCB assembly.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A high voltage power supply, comprising:
switching units to intermit a current flowing in a primary side coil of a switch-connected transformer to control a voltage induced into a secondary side coil of the transformer;
digital control units to control the intermission of the switching units in response to input control data; and
a digital interface unit to provide the digital control units with the control data.

2. The high voltage power supply of claim 1, wherein the control data determine at least one of a waveform of an output voltage, a magnitude of the output voltage, and whether to output the output voltage.

3. The high voltage power supply of claim 1, wherein the switching units, the digital interface unit, and the digital control units are provided on a single chip.

4. The high voltage power supply of claim 1, wherein the digital control unit receives a signal corresponding to an output voltage of the secondary side of the transformer as a feedback signal, and controls a cycle of the intermission of the switching units based on a result of a comparison between the feedback signal and the control data.

5. The high voltage power supply of claim 1, wherein the switching units use a MOSFET as a switching element for the intermission.

6. The high voltage power supply of claim 1, wherein the control data are extracted from a control code that is transferred according to a predetermined communication protocol.

7. An image forming apparatus, comprising a high voltage power supply to generate a voltage, the high voltage power supply comprising:
switching units to intermit a current flowing in a primary side coil of a switch-connected transformer to control a voltage induced into a secondary side coil of the transformer;
digital control units to control the intermission of the switching units in response to input control data; and
a digital interface unit to provide the digital control units with the control data.

8. A method of generating a high voltage, the method comprising:
extracting control data from a control code transferred according to a predetermined communication protocol;
controlling a switching operation of a switching element in response to the control data; and
intermitting a current flowing in a primary side coil of a switch-connected transformer to control a voltage induced into a secondary side coil of the transformer, according to the switching operation.

9. The method of claim 8, further comprising:
receiving an output voltage of the secondary side of the transformer as a feedback signal; and
controlling a cycle of the switching operation based on a result of a comparison between the feedback signal and the control data.

10. The method of claim 9, wherein the extracting, the controlling, the intermitting, and the receiving operations are executed in a single chip.

11. The method of claim 9, wherein the switching element is a MOSFET.

12. An application-specific integrated circuit chip embodied in a semiconductor substrate, comprising:
switching units to intermit a current flowing in a primary side coil of a switch-connected transformer to control a voltage induced into a secondary side coil of the transformer;
digital control units to control the intermission of the switching units in response to an input control data; and
a digital interface unit to provide the digital control units with the control data.

13. The application-specific integrated circuit chip of claim 12, further comprising:
a feedback circuit unit to receive an output voltage of the secondary side of the transformer as a feedback signal, and to control a cycle of the intermission of the switching units based on a result of a comparison between the feedback signal and the control data.

14. The application-specific integrated circuit chip of claim 12, wherein a switching element of the switching units is a MOSFET.

15. The application-specific integrated circuit of claim 12, wherein the control data is extracted from a control code which is transferred according to a predetermined communication protocol.

16. An application-specific integrated circuit chip, comprising:
a digital interface unit to receive control data and to convert the control data into a predetermined format;
a plurality of digital control units to compare the converted control data to a signal reference value and to output driving signals according to the comparison;
a plurality of switching units corresponding to the plurality of digital control units to receive the driving signals and to control a final voltage output; and
a plurality of output units connected to respective ones of the plurality of switching units to output the final voltage.

17. A high voltage power supply comprising a single application-specific integrated circuit chip, the chip comprising:
a digital interface unit to receive control data and to convert the control data into a predetermined format;
a plurality of digital control units to compare the converted control data to a signal reference value and to output driving signals according to the comparison;
a plurality of switching units corresponding to the plurality of digital control units to receive the driving signals and to control a final voltage output; and
a plurality of output units connected to respective ones of the plurality of switching units to output the final voltage.

18. The high voltage power supply of claim 17, wherein each of the plurality of output units comprise a transformer, a voltage multiplying circuit, and a rectifier.

19. The high voltage power supply of claim 18, wherein the plurality of switching units are serially-connected to the transformers of respective ones of the plurality of output units to generate alternate currents of high potential to a secondary side of the transformers.

20. The high voltage power supply of claim 17, wherein each of the plurality of switching units comprises a MOSFET, and wherein the high voltage power supply does not include an insulating plate.

21. The high voltage power supply of claim 17, wherein the chip further comprises:
an oscillator to generate clocks; and
a power-on reset unit to supply a reset signal to the digital interface unit.

22. An electrophotographic image forming apparatus, comprising:
a photoconducting unit;
a charging unit;
a scanning unit;
a developing unit;
a control unit;
a high voltage power supply comprising a single application-specific integrated circuit chip to receive control data and to output driving signals according to the control data; and
an output unit having a transformer to generate one or more high voltages according to the drive signals,
wherein one or more of the photoconducting unit, the charging unit, the scanning unit, and the developing unit operate according to corresponding ones of the high voltages.

23. The electrophotographic image forming apparatus of claim 22, wherein the single application-specific integrated circuit chip comprises:
a digital interface unit to receive control data from the control unit and to convert the control data into a predetermined format;
a plurality of digital control units to compare the converted control data to a signal reference value and to output driving signals according to the comparison;
a plurality of switching units corresponding to the plurality of digital control units to receive the driving signals and to control a final voltage output; and
a plurality of output units connected to respective ones of the plurality of switching units to output the final voltage.

24. The electrophotographic image forming apparatus of claim 22, wherein the apparatus is a multi-color laser beam printer.

25. A method of generating a high voltage, comprising:
converting control data into a predetermined format in a digital interface unit;
comparing the converted control data to a signal reference value in a plurality of digital control units;
outputting driving signals according to the comparison from the plurality of digital control units;
receiving the driving signals in a plurality of switching units corresponding to the plurality of digital control units;
controlling a final voltage output; and
outputting the final voltage using a plurality of output units connected to respective ones of the plurality of switching units.

26. The method of claim 25, wherein the digital interface unit, the plurality of digital control units, the plurality of switching units, and the plurality of output units are located on a single application-specific integrated circuit chip.
